(19) United States
(12) Patent Application Publication
(10) Pub. No.: US 2026/0037069 A1
(43) Pub. Date: Feb. 5, 2026

(54) DEVICE WITH VIRTUAL BUTTONS AND HAPTIC RESPONSE

(71) Applicant: Cirrus Logic International Semiconductor Ltd., Edinburgh (GB)

(72) Inventors: Ron COAPSTICK, Austin, TX (US); Michael KUREK, Austin, TX (US); Kyle WILKINSON, South Lake Tahoe, CA (US); Benjamin YOON, Austin, TX (US)

(73) Assignee: Cirrus Logic International Semiconductor Ltd., Edinburgh (GB)

(21) Appl. No.: 19/222,238

(22) Filed: May 29, 2025

Related U.S. Application Data
(60) Provisional application No. 63/677,210, filed on Jul. 30, 2024.

(51) Int. Cl. G06F 3/01; G06F 3/041; G06F 3/0488

(52) U.S. Cl. CPC G06F 3/016; G06F 3/041; G06F 3/0488; G06F 2203/04105

(57) ABSTRACT

An electronic device may include an enclosure having an outer surface with a defined interaction zone, wherein a user interaction with the defined interaction zone causes a deflection of a mechanical member of the electronic device, a haptic actuator mechanically mounted to an inner surface of the enclosure at the defined interaction zone, and a sensor located proximately to the inner surface of the enclosure and configured to detect the deflection, wherein the haptic actuator is further configured to generate a haptic response responsive to the user interaction upon detection of the deflection by the sensor.

### RELATED APPLICATION

The present disclosure claims priority to U.S. Provisional Patent Application Ser. No. 63/677,210, filed Jul. 30, 2024, which is incorporated by reference herein in its entirety.

### FIELD OF DISCLOSURE

The present disclosure relates in general to electronic devices with user interfaces (e.g., mobile devices, game controllers, instrument panels for vehicles, machinery, and/or appliances, etc.), and more particularly, to an electronic device having virtual buttons that replace traditional mechanical buttons, with such virtual buttons providing a haptic response to a user that mimics the feel of traditional mechanical buttons.

### BACKGROUND

Many traditional mobile devices (e.g., mobile phones, personal digital assistants, video game controllers, etc.) include mechanical buttons to allow for interaction between a user of a mobile device and the mobile device itself. Other systems and devices (e.g., automobiles) may also include mechanical buttons allowing a user to interact. However, because such mechanical buttons are susceptible to aging, wear, and tear that may reduce the useful life of a mobile device and/or may require significant repair if malfunction occurs, mobile device manufacturers are increasingly looking to equip mobile devices with virtual buttons that act as a human-machine interface allowing for interaction between a user of a mobile device and the mobile device itself. Ideally, for best user experience, such virtual buttons should look and feel to a user as if a mechanical button were present instead of a virtual button.

Presently, linear resonant actuators (LRAs) and other vibrational actuators (e.g., rotational actuators, vibrating motors, etc.) are increasingly being used in mobile devices to generate vibrational feedback in response to user interaction with human-machine interfaces of such devices. Typically, a sensor (traditionally a force or pressure sensor) detects user interaction with the device (e.g., a finger press on a virtual button of the device) and in response thereto, the linear resonant actuator may vibrate to provide feedback to the user. However, existing approaches often struggle with effectively transmitting haptic feedback through the device case to a user.

### SUMMARY

In accordance with the teachings of the present disclosure, the disadvantages and problems associated with existing approaches to providing haptic feedback in an electronic device may be reduced or eliminated.

In accordance with embodiments of the present disclosure, an electronic device may include an enclosure having an outer surface with a defined interaction zone, wherein a user interaction with the defined interaction zone causes a deflection of a mechanical member of the electronic device, a haptic actuator mechanically mounted to an inner surface of the enclosure at the defined interaction zone, and a sensor located proximately to the inner surface of the enclosure and configured to detect the deflection, wherein the haptic actuator is further configured to generate a haptic response responsive to the user interaction upon detection of the deflection by the sensor.

In accordance with these and other embodiments of the present disclosure, a method may be provided for an electronic device comprising an enclosure having an outer surface with a defined interaction zone, wherein a user interaction with the defined interaction zone causes a deflection of a mechanical member of the electronic device and comprising a haptic actuator mechanically mounted to an inner surface of the enclosure at the defined interaction zone. The method may include detecting, with a sensor located proximately to the inner surface of the enclosure, the deflection and generating, with the haptic actuator, a haptic response responsive to the user interaction upon detection of the deflection by the sensor.

Technical advantages of the present disclosure may be readily apparent to one having ordinary skill in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of selected components of an example electronic device, in accordance with embodiments of the present disclosure; and

FIG. 2 illustrates an elevation view of selected components within a virtual button interaction zone of the electronic device of FIG. 1, in accordance with embodiments of the present disclosure.

### DETAILED DESCRIPTION

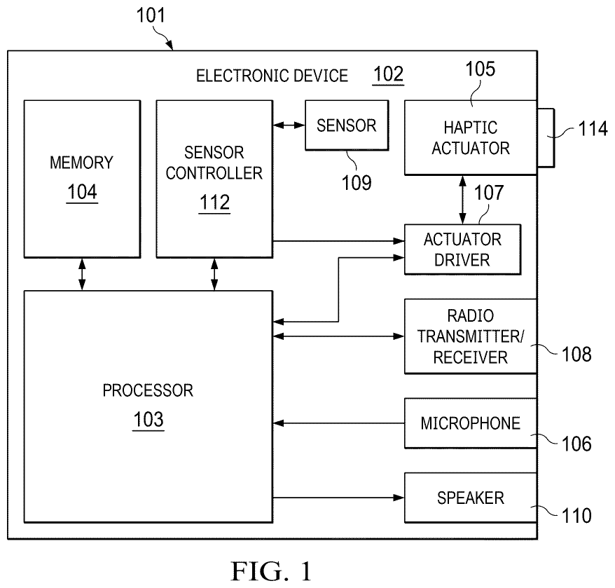

FIG. 1 illustrates a block diagram of selected components of an example electronic device 102, in accordance with embodiments of the present disclosure. As shown in FIG. 1, electronic device 102 may comprise an enclosure 101, a processor 103, a memory 104, a haptic actuator 105, a microphone 106, an actuator driver 107, a radio transmitter/receiver 108, a sensor 109, a speaker 110, a sensor controller 112, and a virtual button 114.

Enclosure 101 may comprise any suitable housing, casing, chassis, or other enclosure for housing the various components of electronic device 102. Enclosure 101 may be constructed from plastic, metal, and/or any other suitable materials. In addition, enclosure 101 may be adapted (e.g., sized and shaped) such that electronic device 102 is readily transported on a person of a user of electronic device 102. Accordingly, electronic device 102 may include but is not limited to a smart phone, a tablet computing device, a handheld computing device, a personal digital assistant, a notebook computer, a video game controller, or any other device that may be readily held, carried, and/or transported on a person of a user of electronic device 102. In other embodiments, electronic device 102 may have a larger enclosure, for example a dashboard of a vehicle.

Processor 103 may be housed within enclosure 101 and may include any system, device, or apparatus configured to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or other computer-readable media accessible to processor 103.

Memory 104 may be housed within enclosure 101, may be communicatively coupled to processor 103, and may include any system, device, or apparatus configured to retain program instructions and/or data for a period of time (e.g., computer-readable media). Memory 104 may include random access memory (RAM), electrically erasable programmable read-only memory (EEPROM), a Personal Computer Memory Card International Association (PCMCIA) card, flash memory, magnetic storage, opto-magnetic storage, or any suitable selection and/or array of volatile or non-volatile memory that retains data after power to electronic device 102 is turned off.

Microphone 106 may be housed at least partially within enclosure 101, may be communicatively coupled to processor 103, and may comprise any system, device, or apparatus configured to convert sound incident at microphone 106 to an electrical signal that may be processed by processor 103, wherein such sound is converted to an electrical signal using a diaphragm or membrane having an electrical capacitance that varies based on sonic vibrations received at the diaphragm or membrane. Microphone 106 may include an electrostatic microphone, a condenser microphone, an electret microphone, a microelectromechanical systems (MEMS) microphone, or any other suitable capacitive microphone.

Radio transmitter/receiver 108 may be housed within enclosure 101, may be communicatively coupled to processor 103, and may include any system, device, or apparatus configured to, with the aid of an antenna, generate and transmit radio-frequency signals as well as receive radio-frequency signals and convert the information carried by such received signals into a form usable by processor 103. Radio transmitter/receiver 108 may be configured to transmit and/or receive various types of radio-frequency signals, including without limitation, cellular communications (e.g., 2G, 3G, 4G, LTE, etc.), short-range wireless communications (e.g., BLUETOOTH), commercial radio signals, television signals, satellite radio signals (e.g., GPS), Wireless Fidelity, etc. In some embodiments, other methods for communication (e.g., wired, optical, etc.) may be used in lieu of or in addition to radio transmitter/receiver 108.

A speaker 110 may be housed at least partially within enclosure 101 or may be external to enclosure 101, may be communicatively coupled to processor 103, and may comprise any system, device, or apparatus configured to produce sound in response to electrical audio signal input. In some embodiments, a speaker may comprise a dynamic loudspeaker, which employs a lightweight diaphragm mechanically coupled to a rigid frame via a flexible suspension that constrains a voice coil to move axially through a cylindrical magnetic gap. When an electrical signal is applied to the voice coil, a magnetic field is created by the electric current in the voice coil, making it a variable electromagnet. The voice coil and the driver's magnetic system interact, generating a mechanical force that causes the voice coil (and thus, the attached cone) to move back and forth, thereby reproducing sound under the control of the applied electrical signal coming from the amplifier.

Haptic actuator 105 may be housed within enclosure 101, and may include any suitable system, device, or apparatus for producing an oscillating mechanical force across a single axis. For example, in some embodiments, haptic actuator 105 may rely on an alternating current voltage to drive a voice coil pressed against a moving mass connected to a spring. When the voice coil is driven at the resonant frequency of the spring, haptic actuator 105 may vibrate with a perceptible force. Thus, haptic actuator 105 may be useful in haptic applications within a specific frequency range. While, for the purposes of clarity and exposition, this disclosure is described in relation to the use of haptic actuator 105, it is understood that any other type or types of vibrational actuators (e.g., eccentric rotating mass actuators, piezoelectric actuators, solenoid actuators, shaped metal alloy actuators, voice coil motors, and voice coil actuators) may be used in lieu of or in addition to haptic actuator 105. In addition, it is also understood that actuators arranged to produce an oscillating mechanical force across multiple axes may be used in lieu of or in addition to haptic actuator 105. As described elsewhere in this disclosure, a haptic actuator 105, based on a signal received from actuator driver 107, may render haptic feedback to a user of electronic device 102 for at least one of mechanical button replacement and touch, force, and/or position sensor feedback.

Actuator driver 107 may comprise any suitable system, device, or apparatus for driving a signal to actuate haptic actuator 105. As described in greater detail below, actuator driver 107 may generate such driving signal for haptic actuator 105 in response to a user interaction with virtual button 114. In some embodiments, actuator driver 107 may be configured to monitor operation of haptic actuator 105 (e.g., through sensing of a voltage and/or a current associated with haptic actuator 105), to ensure accurate control of haptic actuator 105.

Sensor 109 may be housed within enclosure 101, and may include any system, device, or apparatus configured to detect a physical interaction with (e.g., proximity to, touch to, and/or displacement of) the human-machine interface of electronic device 102 (e.g., a force applied by a human finger to virtual button 114). In some embodiments, sensor 109 may detect physical interaction with a metal member. In some embodiments, such metal member may be part of enclosure 101. In other embodiments, such metal member may be integral to haptic actuator 105 or a housing of haptic actuator 105.

In these and other embodiments, sensor 109 may perform resonant phase sensing of a resistive-inductive-capacitive sensor for which an impedance (e.g., inductance, capacitance, and/or resistance) of the resistive-inductive-capacitive sensor changes in response to physical interaction with the metal member. For example, in some embodiments, sensor 109 may comprise an inductive-based sensor, such as that described in U.S. Pat. No. 10,908,200, which is incorporated by reference herein in its entirety. However, in other embodiments, sensor 109 may comprise a capacitive proximity sensor or other suitable sensor.

Accordingly, haptic actuator 105 may comprise any suitable system, device, or apparatus which all or a portion thereof may be physically interacted with, and physical interaction may cause a change in an impedance of a resistive-inductive-capacitive sensor which includes haptic actuator 105. For example, in some embodiments, haptic actuator 105 may comprise a piezoelectric actuator, shaped metal alloy actuator, or solenoid actuator, capable of mechanical vibration in response to an electric field applied to it (e.g., in order to generate haptic effects), and/or also capable of generating an electrical signal (e.g., which may be sensed by sensor 109) in response to force applied to it.

In some embodiments, haptic actuator 105 and sensor 109 may be implemented within the same flexible circuit (e.g., a flexible printed circuit board or similar device). Such an approach may minimize part count and complexity as the entire virtual button assembly may require only a single flexible element comprising the necessary electrical connections.

Sensor controller 112 may be housed within enclosure 101, may be communicatively coupled to actuator driver 107 and sensor 109, and may include any system, device, or apparatus configured to monitor deflection of the metal member, as sensed by sensor 109, and determine if the monitored deflection indicates a user interaction with virtual button 114. As example of such a detection system that may be implemented by sensor controller 112 is described in U.S. Pat. No. 11,269,509, which is incorporated by reference herein in its entirety. Upon detection of such a user interaction, sensor controller 112 may communicate an appropriate signal to actuator driver 107 to trigger a haptic response of haptic actuator 105 to the user interaction.

In some embodiments, sensor controller 112 may comprise a single integrated circuit. In some of such embodiments, such single integrated circuit may also include one or both of sensor 109 and actuator driver 107, for example as described in U.S. Pat. No. 11,500,469, which is incorporated by reference herein in its entirety. In alternative embodiments, sensor controller 112 and actuator driver 107 may be implemented with separate integrated circuits communicatively coupled to each other.

In some embodiments, one or more of processor 103, actuator driver 107, sensor 109, and sensor controller 112 may be implemented together on a single integrated circuit.

As shown in FIG. 1, sensor controller 112 and actuator driver 107 may each be coupled with processor 103, such that information regarding operation of haptic actuator 105 and sensor 109 may be communicated to processor 103, and/or such that processor 103 may also generate signals for control of haptic actuator 105 and sensor 109.

Virtual button 114 may comprise any system, device, or apparatus that defines for a user a defined interaction zone for interacting with a virtual button, such that user interaction with such a virtual button 114 causes deflection in a surface of enclosure 101 or deflection elsewhere proximate to the surface of enclosure 101 (e.g., a deflection of haptic actuator 105 or a housing of haptic actuator 105), wherein such deflection may be sensed by sensor 109. In some embodiments, virtual button 114 may provide a visual indication of a location of a virtual button (e.g., a raised region on enclosure 101 providing visual indication of a location of the virtual button). Further, virtual button 114 may be mechanically coupled to haptic actuator 105, such that when a user interacts with virtual button 114, haptic actuator 105 generates a haptic effect that the user senses via virtual button 114.

Together, haptic actuator 105, actuator driver 107, sensor 109, sensor controller 112, and virtual button 114 may form a human-interface device, such as a virtual button, which, to a user of electronic device 102, has a look and feel of a mechanical button of electronic device 102. In operation, such a virtual button may implement a function to enable a user to control electronic device 102, such as controlling a volume of sound output by speaker 110, for example.

Although specific example components are depicted above in FIG. 1 as being integral to electronic device 102 (e.g., processor 103, memory 104, mechanical member 105, microphone 106, radio transmitter/receiver 108, speakers(s) 110, haptic actuator 105, etc.), an electronic device 102 in accordance with this disclosure may comprise one or more components not specifically enumerated above. For example, although FIG. 1 depicts certain user interface components, electronic device 102 may include one or more other user interface components in addition to those depicted in FIG. 1, including but not limited to a keypad, a touch screen, and a display, thus allowing a user to interact with and/or otherwise manipulate electronic device 102 and its associated components. In addition, although FIG. 1 depicts one virtual button 114 for purposes of clarity and exposition, in some embodiments electronic device 102 may have multiple virtual buttons each associated with a respective virtual button 114.

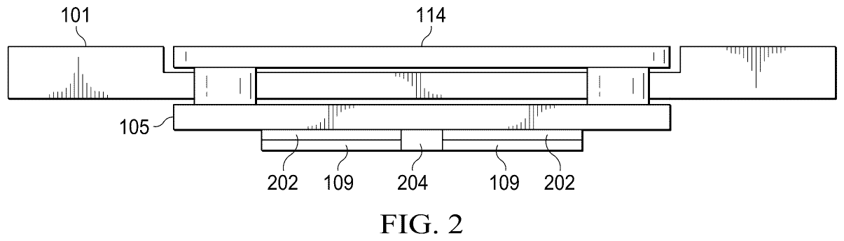

FIG. 2 illustrates an elevation view of selected components within a virtual button interaction zone of electronic device 102, in accordance with embodiments of the present disclosure. As shown in FIG. 2, virtual button 114 may be formed within or upon enclosure 101 such that virtual button 114 is visible from the outside of enclosure 101. In some embodiments, virtual button 114 may include one or more features (e.g., “plungers”) that extend partially or fully through enclosure 101 such that, when a user applies a force to virtual button 114, a portion of enclosure 101 and/or haptic actuator 105 mechanically deflects.

As also shown in FIG. 2, haptic actuator 105 may be mechanically mounted to an inner surface of enclosure 101 proximate to virtual button 114. Further as shown in FIG. 2, sensor 109 may be located proximate to such inner surface of enclosure 101 in order to detect deflection of enclosure 101 and/or haptic actuator 105. In some embodiments, a pliable filler material 202 (e.g., foam or rubber) may be mechanically interfaced between haptic actuator 105 and sensor 109. In other embodiments, haptic actuator 105 and sensor 109 may be separated by an air gap in lieu of a pliable filter material.

FIG. 2 illustrates an architecture in which two sensors 109, separated by a mechanical spacer 204, may be used to detect interaction along the surface of virtual button 114. For example, one sensor 109 may detect interaction at the left-most portion of virtual button 114, while another sensor 109 may detect interaction at the right-most portion of virtual button 114. An example use of such an architecture may be a volume control, where a user may indicate a desire to increase sound volume by interacting with the left-most portion of virtual button 114 and decrease sound volume by interacting with the right-most portion of virtual button 114 (or vice versa). Another example use of such an architecture may be for a user to cause content of a display to scroll by swiping across the surface of virtual button 114.

With haptic actuator 105 mechanically mounted to the inner surface of enclosure 101 at the interaction zone defined by virtual button 114, the haptic response generated by haptic actuator 105 may be more effectively and efficiently provided to a user interacting with virtual button 114, as compared to existing approaches, because the haptic response effect may be directly to the surface of enclosure 101 contacting the user's finger, thus enhancing tactile feedback, and making the feedback feel localized to the user, such that the feedback mimics a mechanical button interaction.

Although the foregoing contemplates haptic actuator 105 and sensor 109 being separate devices, in some embodiments, haptic actuator 105 may be configured to perform sensing as well. For example, in embodiments in which haptic actuator 105 is a piezoelectric actuator, haptic actuator 105 may sense force applied to it by user interaction with virtual button 114, and as a result of the piezoelectric effect, generate an electrical signal (e.g., to sensor controller 112) as a function of such force to indicate user interaction.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. An electronic device comprising:
an enclosure having an outer surface with a defined interaction zone, wherein a user interaction with the defined interaction zone causes a deflection of a mechanical member of the electronic device;
a haptic actuator mechanically mounted to an inner surface of the enclosure at the defined interaction zone; and
a sensor located proximately to the inner surface of the enclosure and configured to detect the deflection;
wherein the haptic actuator is further configured to generate a haptic response responsive to the user interaction upon detection of the deflection by the sensor.

2. The electronic device of claim 1, wherein the mechanical member is a metal member.

3. The electronic device of claim 1, wherein the mechanical member is a portion of the enclosure at the defined interaction zone.

4. The electronic device of claim 1, wherein the mechanical member is integral to the haptic actuator.

5. The electronic device of claim 1, wherein the sensor is configured to detect the deflection based on a change in an inductance associated with the mechanical member.

6. The electronic device of claim 1, wherein the sensor is configured to detect the deflection based on a change in a capacitance associated with the mechanical member.

7. The electronic device of claim 1, wherein the haptic actuator is a piezoelectric actuator.

8. The electronic device of claim 7, wherein the sensor is integral to the haptic actuator and is configured to generate a sensed signal indicative of the user interaction based on a force applied to the haptic actuator by the user interaction.

9. The electronic device of claim 1, wherein the haptic actuator is one of a voice coil motor and a voice coil actuator.

10. The electronic device of claim 1, wherein the haptic actuator is a solenoid actuator.

11. The electronic device of claim 1, wherein the haptic actuator is a shaped metal alloy actuator.

12. The electronic device of claim 1, wherein the haptic actuator and the sensor are integral to a flexible circuit mounted to the inner surface of the enclosure at the defined interaction zone.

13. The electronic device of claim 1, wherein an air gap is formed between the haptic actuator and the sensor.

14. The electronic device of claim 1, wherein a pliable interface material is interfaced between the haptic actuator and the sensor.

15. The electronic device of claim 1, wherein the defined interaction zone comprises at least one virtual button defined on the outer surface of the enclosure.

16. A method, in an electronic device comprising an enclosure having an outer surface with a defined interaction zone, wherein a user interaction with the defined interaction zone causes a deflection of a mechanical member of the electronic device and comprising a haptic actuator mechanically mounted to an inner surface of the enclosure at the defined interaction zone, the method comprising:
detecting, with a sensor located proximately to the inner surface of the enclosure, the deflection; and
generating, with the haptic actuator, a haptic response responsive to the user interaction upon detection of the deflection by the sensor.

17. The method of claim 16, wherein the mechanical member is a metal member.

18. The method of claim 16, wherein the mechanical member is a portion of the enclosure at the defined interaction zone.

19. The method of claim 16, wherein the mechanical member is integral to the haptic actuator.

20. The method of claim 16, further comprising detecting, with the sensor, the deflection based on a change in an inductance associated with the mechanical member.

21. The method of claim 16, further comprising detecting, with the sensor, the deflection based on a change in a capacitance associated with the mechanical member.

22. The method of claim 16, wherein the haptic actuator is a piezoelectric actuator.

23. The method of claim 22, wherein the sensor is integral to the haptic actuator and the method further comprises generating, with the sensor, a sensed signal indicative of the user interaction based on a force applied to the haptic actuator by the user interaction.

24. The method of claim 16, wherein the haptic actuator is one of a voice coil motor and a voice coil actuator.

25. The method of claim 16, wherein the haptic actuator is a solenoid actuator.

26. The method of claim 16, wherein the haptic actuator is a shaped metal alloy actuator.

27. The method of claim 16, wherein the haptic actuator and the sensor are integral to a flexible circuit mounted to the inner surface of the enclosure at the defined interaction zone.

28. The method of claim 16, wherein an air gap is formed between the haptic actuator and the sensor.

29. The method of claim 16, wherein a pliable interface material is interfaced between the haptic actuator and the sensor.

30. The method of claim 16, wherein the defined interaction zone comprises at least one virtual button defined on the outer surface of the enclosure.
